(19) United States
(12) Patent Application Publication
(10) Pub. No.: US 2014/0115153 A1
(43) Pub. Date: Apr. 24, 2014

(54) APPARATUS FOR MONITORING DATA DISTRIBUTION SERVICE (DDS) AND METHOD THEREOF

(71) Applicant: Electronics and Telecommunications Research Institute, Daejeon (KR)

(72) Inventors: Kyung Il KIM, Daejeon (KR); Soo Hyung LEE, Daejeon (KR); Hyung Kook JUN, Seoul (KR); Kyeong Tae KIM, Daejeon (KR); Yong Yeon KIM, Daejeon (KR); Won Tae KIM, Asan (KR)

(73) Assignee: Electronics and Telecommunications Research Institute, Daejeon (KR)

(21) Appl. No.: 13/966,198

(22) Filed: Aug. 13, 2013

(30) Foreign Application Priority Data
Oct. 23, 2012 (KR) 10-2012-0117576

(51) Int. Cl. H04L 12/26

(52) U.S. Cl. CPC H04L 43/10
USPC 709/224

(57) ABSTRACT

An apparatus for monitoring a data distribution service (DDS), and a method thereof are disclosed. A DDS monitoring apparatus monitoring a data distribution service (DDS) includes: a monitoring participant configured to receive a monitoring topic from a DDS node, wherein the monitoring topic is status information of the DDS node; a monitoring data collector configured to collect the monitoring topic, and to determine whether or not the monitoring topic is urgent; and a monitoring data analyzer configured to analyze the monitoring topic according to whether or not the monitoring topic is urgent to determine whether to create DDS status information corresponding to the status of the DDS node. Accordingly, it is possible to monitor a DDS in real time.

### CLAIM FOR PRIORITY

This application claims priority to Korean Patent Application No. 10-2012-0117576 filed on Oct. 23, 2012 in the Korean Intellectual Property Office (KIPO), the entire contents of which are hereby incorporated by reference.

### BACKGROUND

1. Technical Field

Example embodiments of the present invention relate in general to technology for improving the reliability and real-time performance of a data distribution service (DDS), and more specifically, to an apparatus and method for monitoring a data distribution service (DDS).

2. Related Art

Data distribution service (DDS) communication middleware has been developed for a data distribution environment, and enacted as a standard in 2004 by the Object Management Group (OMG). In other words, the DDS communication middleware is middleware having a publish/subscribe specification for a data distribution environment, and has been developed in response to a need for standardization of a data-centric publish/subscribe programming model for a data distribution environment.

In detail, the DDS communication middleware dynamically establishes a network domain for a data distribution environment, and provides efficient data distribution using a publish/subscribe communication method in an environment allowing free participation/withdrawal of devices.

Conventional data distributed object models, such as a Common Object Request Broker Architecture (CORBA) and a Distributed Component Object Model (DCOM), have many advantages in view of resource sharing, the possibility of objects reuse, etc. However, since the CORBA and DCOM use a remote procedure call as a method for distributing data to enable a program in a computer to call a procedure which is a sub-program in another computer located distant from the computer, the CORBA and DCOM are inefficient in terms of delay time, bandwidth, etc. in an environment in which a large amount of data should be quickly distributed and exchanged. In detail, the CORBA and DCOM call a sub-program in another computer, instead of exchanging data in real time, thereby processing data distribution, etc. Accordingly, when a large amount of data needs to be distributed, many procedures need to be called. However, a great amount of time is required to call many procedures, and even a bandwidth that can be allocated to the procedures is limited.

On the other hand, the DDS communication middleware enables a plurality of users to establish a dynamic network regardless of a physical network so that the users as publishers and subscribers can reliably transfer their desired information in real time.

Due to the characteristics of the DDS communication middleware, the OMG recommends use of the DDS communication middleware for services requiring high reliability and real-time performance, such as C4I, industrial automation, distributed control and simulation, control of communication devices, a sensor network, a network management system, etc.

In order to monitor the generation of errors upon execution of the DDS communication middleware, monitoring software tools (hereinafter, for purposes of simplicity of explanation, referred to as a “monitoring apparatus”) are provided. However, since an existing DDS monitoring apparatus adds overhead to a network and a system, there are difficulties in recognizing the data flow between data nodes.

Overload generated in the DDS monitoring apparatus relates to the communication structure of the DDS communication middleware. In detail, the DDS monitoring apparatus uses a separate protocol, for example, a simple network management protocol (SNMP) for recognizing a data distribution flow, etc. The protocol is executed by a method in which a DDS monitoring apparatus requests information for monitoring a DDS to a data node, and receives the requested information from the data node for monitoring the DDS. However, it takes a great amount of time for the DDS monitoring apparatus to collect the information for monitoring the DDS, and transmit the collected information.

That is, since the conventional DDS monitoring apparatus which requests information in a data node and receives the requested information from the data node does not use the data distribution function of the DDS communication middleware, it takes a great amount of time to collect information for managing the DDS.

Accordingly, it is difficult for the conventional DDS monitoring apparatus to perform immediate and real time DDS monitoring.

### SUMMARY

Accordingly, example embodiments of the present invention are provided to substantially obviate one or more problems due to limitations and disadvantages of the related art.

Example embodiments of the present invention provide a data distribution service (DDS) monitoring apparatus capable of monitoring a DDS in real time by transmitting data for DDS monitoring by using a topic.

Example embodiments of the present invention also provide a DDS monitoring method capable of quick processing an error and defect generated in a DDS node by allowing a manager to recognize the error and defect in real time.

In some example embodiments, a DDS monitoring apparatus includes: a monitoring participant configured to receive a monitoring topic from a DDS node, wherein the monitoring topic is status information of the DDS node; a monitoring data collector configured to collect the monitoring topic, and to determine whether or not the monitoring topic is urgent; and a monitoring data analyzer configured to analyze the monitoring topic according to whether or not the monitoring topic is urgent to determine whether to create DDS status information corresponding to the status of the DDS node. The DDS monitoring apparatus may further include a monitoring data visualizer configured to visualize at least one of the status information of the DDS and the monitoring topic on a screen.

The DDS monitoring apparatus may further include a monitoring data storage configured to store the monitoring topic.

The monitoring data collector may provide the monitoring topic to the monitoring data visualizer if the monitoring topic is urgent, and if the monitoring topic is not urgent, the monitoring data collector may store the monitoring topic in the monitoring data storage so that the stored monitoring data is analyzed.

The monitoring participant may include a monitoring subscriber configured with a monitoring reader for receiving the monitoring topic from the DDS node.

The monitoring topic may be defined according to a method of defining a predetermined data topic, and stored in DDS communication middleware.

In other example embodiments, a DDS node interworking with a DDS monitoring apparatus includes: an application configured to execute an installed application program to perform a task allocated to the DDS node; a data participant configured to transmit/receive data using a topic; and a monitoring participant configured to collect a monitoring topic which is information generated when the task is performed and when the data is transmitted/received, and to provide the monitoring topic to the DDS monitoring apparatus.

The DDS node may provide the monitoring topic to the DDS monitoring apparatus through DDS communication middleware.

The data participant may include a data publisher for transmitting the data, and a data subscriber for receiving the data.

In still other example embodiments, a data distribution service (DDS) monitoring method of a DDS monitoring apparatus includes: receiving a monitoring topic from a DDS node, wherein the monitoring topic is status information of the DDS node; collecting the monitoring topic, and determining whether or not the monitoring topic is urgent; and analyzing the monitoring topic according to whether or not the monitoring topic is urgent to determine whether to create DDS status information corresponding to the status of the DDS node.

The DDS monitoring method may further include visualizing at least one of the DDS status information and the monitoring topic on a screen.

The DDS monitoring method may further include storing the monitoring topic if the monitoring topic is not urgent.

The collecting of the monitoring topic may include: visualizing the monitoring topic on the screen if the monitoring topic is urgent; and storing the monitoring topic if the monitoring topic is not urgent so that the stored monitoring topic is used in the analyzing of the monitoring topic.

The monitoring topic may be defined according to a method of defining a predetermined data topic, and stored in DDS communication middleware.

### BRIEF DESCRIPTION OF DRAWINGS

Example embodiments of the present invention will become more apparent by describing in detail example embodiments of the present invention with reference to the accompanying drawings, in which:

FIG. 1 is a conceptual view schematically illustrating the configuration of a data distribution service (DDS) system to which a DDS monitoring apparatus according to an embodiment of the present invention is applied;

FIG. 2 is a view illustrating the hierarchical structure of an example of DDS communication middleware;

FIG. 3 is a block diagram illustrating the configuration of a DDS node together with DDS communication middleware in order to explain operation in which the DDS node transmits/receives data through the DDS communication middleware;

FIG. 4 is a block diagram schematically illustrating the configuration of a DDS monitoring apparatus according to an embodiment of the present invention in order to explain operation in which the DDS monitoring apparatus receives a monitoring topic from a DDS node through DDS communication middleware; and

FIG. 5 is a flowchart illustrating a method in which the DDS monitoring apparatus monitors a DDS node according to an embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, A, B, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present invention will be described in detail with reference to the appended drawings.

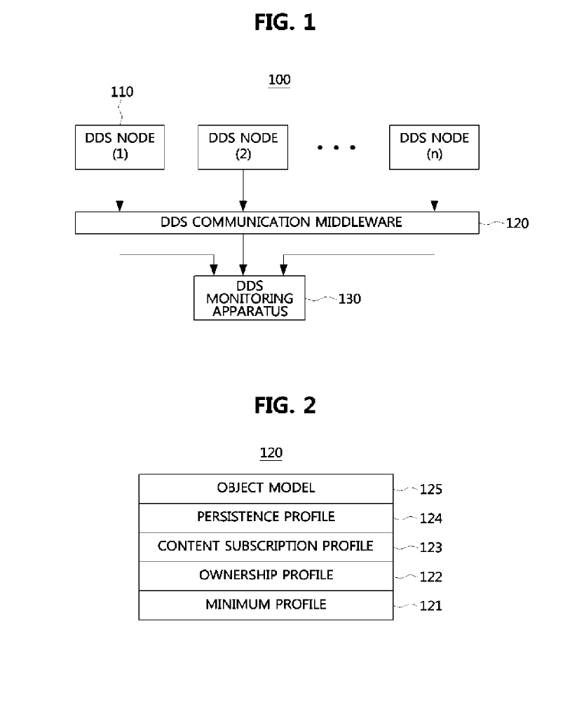

FIG. 1 is a conceptual view schematically illustrating the configuration of a data distribution service (DDS) system 100 to which a DDS monitoring apparatus 130 according to an embodiment of the present invention is applied. Hereinafter, for convenience of description, the data distribution service will be referred to as a “DDS.”

First, as illustrated in FIG. 1, the DDS system 100 may include a plurality of DDS nodes 110, DDS communication middleware 120, and a DDS monitoring apparatus 130. In detail, the plurality of DDS nodes 110 (110 for each) may be configured with n nodes, and each DDS node 110 is a computing apparatus in which applications are installed and which receives/transmits data from/to another DDS node 110 through the DDS communication middleware 120.

That is, the individual DDS nodes 110 may store application programs for performing different functions, and receive/transmit desired data from/to the other DDS nodes 110 through the DDS communication middleware 120.

Meanwhile, each DDS node 110 should use a predetermined data format to exchange data with another DDS node 110 through the DDS communication middleware 120. The predetermined data format is called a “topic” in a DDS standard. In other words, a “topic” is a basic data structure that is represented by the interface definition language of the Object

Management Group (OMG). If there is a request for mixing different languages, a formalized reader and writer with respect to a topic are automatically created.

The DDS communication middleware 120 has a data-based publish/subscribe model as a communication middleware standard for a data distribution environment, and transfers data between the DDS nodes 110.

Also, the DDS communication middleware 120 transfers a monitoring topic (MT of

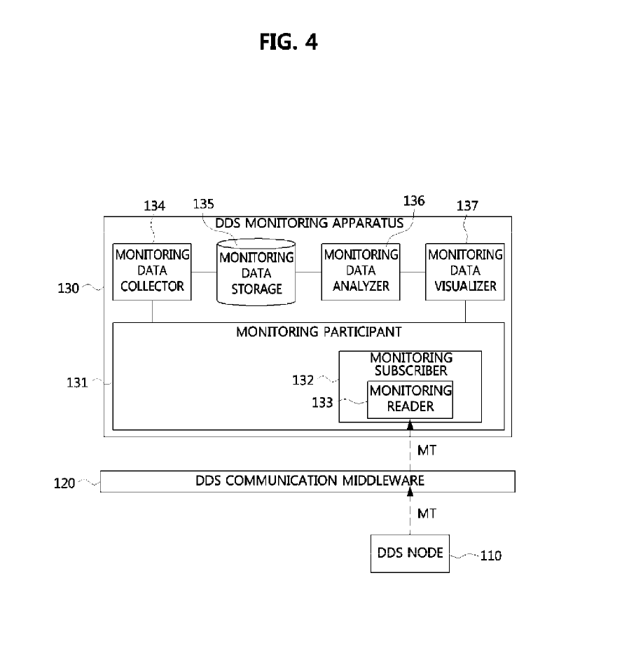

FIG. 3) which is information for monitoring a DDS between the DDS nodes 110 and the DDS monitoring apparatus 130. This will be described in more detail with reference to FIGS. 3 and 4.

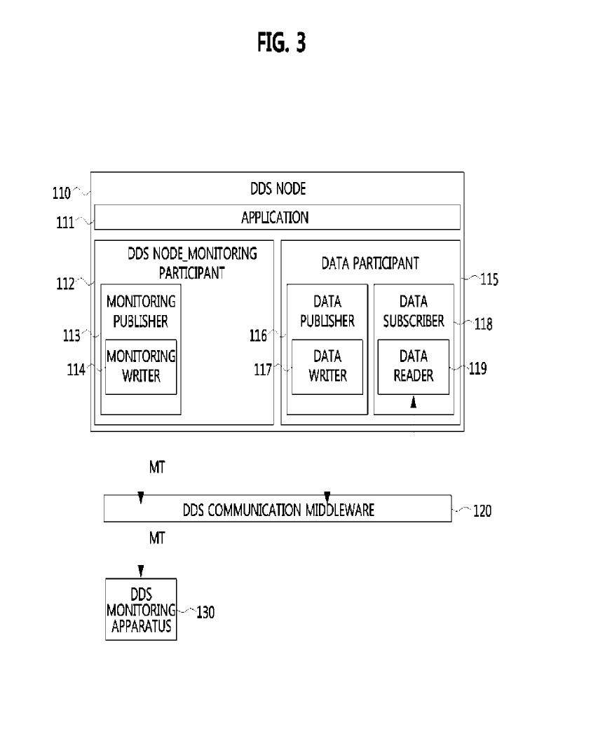

Hereinafter, the DDS communication middleware 120 will be described in more detail with reference to FIG. 2.

FIG. 2 is a view illustrating the hierarchical structure of an example of the DDS communication middleware 120.

As illustrated in FIG. 2, the DDS communication middleware 120 may include a minimum profile 121, an ownership profile 122, a content subscription profile 123, a persistence profile 124, and an object model 125.

The minimum profile 121 is a basic profile, and uses a paradigm of publish/subscribe in order to implement high efficiency of information distribution between a publisher and a subscriber. Also, the minimum profile 121 provides a function of satisfying the parameters of a requesting and providing QoS by including a Quality of Service (QoS) framework. That is, the minimum profile 121 provides basic QoS attributes, such as reliability, ordering, or urgency.

The ownership profile 122 is a replication profile, and enables each publisher to have the strength of information ownership to thereby allow a plurality of publishers to provide the same information through replication. Also, the ownership profile 122 may control such that only information of a publisher having the highest strength among publishers is available.

The content subscription profile 123 is a content awareness profile, and provides a strong function capable of extracting content-of-interest from among specific information content. That is, the content subscription profile 123 functions as a content filter. Also, the content subscription profile 123 defines data group and projection views, such as a dynamic query regarding a topic subscribed to an application. The definition of data groups and projection views is performed using a part of a structured query language (SQL) that ensures a real-time request for accessing information.

The persistence profile 124 is a durability profile, and provides transparency and fault-tolerance for non-volatile data. Accordingly, data is stored in the storage through a persistence setting. Also, data is maintained for a fault-tolerant function for subscribers not connected to a publisher. That is, the persistence profile 124 allows the late subscription of subscribers and even dynamically reallocates data.

The object model 125 is an extended function to allow object-oriented access of the above-described four profiles, that is, the minimum profile 121, the ownership profile 122, the content subscription profile 123, and the persistence profile 124. In other words, the object model 125 provides typical object-oriented functions, such as use of a value-type, inheritance, and navigation, etc.

Referring again to FIG. 1, the DDS monitoring apparatus 130 performs an operation of collecting monitored data of the DDS nodes 110 from the DDS nodes 110 and analyzing the collected data.

Accordingly, the DDS monitoring apparatus 130 may monitor the operations of the DDS nodes 110, that is, the data flow between the DDS nodes 110 and a network status.

Hereinafter, the DDS node 110 according to an embodiment of the present invention will be described in more detail with reference to FIG. 3.

FIG. 3 is a block diagram illustrating the configuration of the DDS node 110 according to an embodiment of the present invention together with the DDS communication middleware 120 in order to explain an operation in which the DDS node 110 transmits/receives data through the DDS communication middleware 120.

As illustrated in FIG. 3, the DDS node 110 may include an application 111, a DDS node_monitoring participant 112, and a data participant 115.

Here, the application 111 functions to perform a task given to the corresponding DDS node 110. That is, the application 111 stores an application program corresponding to a task given to the DDS node 110 to enable the DDS node 110 to perform the task allocated to the DDS node 110.

The DDS node_monitoring participant 112 collects DAF which is information about the operational record of history of the DDS node 110, and provides the collected DAF to the DDS monitoring apparatus 130.

Here, the DAF includes information regarding whether the DDS node 110 normally operates and publishes data, or whether the application 111 normally operates, etc.

The DDS node_monitoring participant 112 may include a monitoring publisher 113 for collecting and providing the DAF. At this time, the DDS node_monitoring participant 112 may further include a monitoring writer 114 for transmitting a monitoring topic (MT) which is monitoring information of the DDS node 110 to the DDS monitoring apparatus 130.

That is, the DDS node_monitoring participant 112 provides an MT to the DDS monitoring apparatus 130 through the monitoring writer 114 of the monitoring publisher 113.

Meanwhile, the DDS node_monitoring participant 112 provides the MT in the form of a data topic to the DDS monitoring apparatus 130.

Here, the form of a data topic is a predetermined data format as described above. The MT may be defined according to a method of defining a data topic. Also, the MT may be pre-defined and stored in the DDS communication middleware 120.

As such, according to the current embodiment, data (that is, an MT) for monitoring of the DDS node 110 is provided to the DDS monitoring apparatus 130 using the data distribution function of the DDS communication middleware 120, instead of using a separate protocol. Accordingly, it is unnecessary to install a separate protocol for exchanging MTs, thereby making it possible to minimize a cost of installing the DDS monitoring apparatus 130.

Meanwhile, in FIG. 3, the DDS node_monitoring participant 112 is shown to include only the monitoring publisher 113 for transmitting an MT. However, the DDS monitoring apparatus 130 may add a function of adjusting the configuration of the DDS node 110. In this case, the DDS node monitoring participant 112 of the DDS node 110 may further include a monitoring subscriber in order to receive data from the DDS monitoring apparatus 130 for adjusting the configuration of the DDS node 110.

The data participant 115 provides a function for data exchange with another DDS node 110 (see FIG. 1).

In detail, the data participant 115 receives data needed by the corresponding DDS node 110 from another DDS node 110, and provides data which has requested to another DDS node 110.

For the operation, the data participant 115 may include a data publisher 116 for publishing data, and the data publisher 116 may further include a data writer 117 for transmitting data.

That is, the data participant 115 transmits data through the data writer 117 of the data publisher 116.

Also, the data participant 115 may include a data subscriber 118 for receiving data, and the data subscriber 118 may further include a data reader 119 for receiving data.

That is, the data participant 115 receives data through the data reader 119 of the data subscriber 118.

Meanwhile, the data participant 115 uses a topic which is a data structure defined by the OMG, as described above, in order to transmit/receive data.

Hereinafter, referring to FIG. 4, the DDS monitoring apparatus 130 according to an embodiment of the present invention will be described in more detail.

FIG. 4 is a block diagram schematically illustrating the configuration of the DDS monitoring apparatus 130 according to an embodiment of the present invention in order to explain an operation in which the DDS monitoring apparatus 130 receives an MT from the DDS node 110 through the DDS communication middleware 120.

As illustrated in FIG. 4, the DDS monitoring apparatus 130 may include a monitoring participant 131, a monitoring data collector 134, a monitoring data storage 135, a monitoring data analyzer 136, and a monitoring data visualizer 137.

The monitoring participant 131 receives an MT transmitted from the monitoring writer (114 of FIG. 3) of the DDS node 110, and provides the MT to the monitoring data collector 134.

For the operation, the monitoring participant 131 may include a monitoring subscriber 132 for receiving a MT, and the monitoring subscriber 132 may further include a monitoring reader 133.

That is, the monitoring participant 131 receives an MT provided by the DDS node 110 through the monitoring reader 133 of the monitoring subscriber 132.

The monitoring data collector 134 stores the MT received from the monitoring participant 131 in the monitoring data storage 135.

Meanwhile, there may be cases in which the content of the MT relates to an error or defect generated in the DDS node 110 or in which the content of the MT needs to be quickly transmitted to a user. In these cases, the monitoring data collector 134 provides the MT to the monitoring data visualizer 137 without storing the MT in the monitoring data storage 135 so that the MT is visualized on a screen.

The monitoring data storage 135 stores the MT provided by the monitoring data collector 134.

The monitoring data analyzer 136 analyzes the MT stored in the monitoring data storage 135 to calculate statistics, and thereby recognizes the data flow between the DDS nodes 110 and a network status (that is, the status of the DDS communication middleware 120).

The monitoring data visualizer 137 visualizes the data flow and the network status (that is, the status of the DDS communication middleware 120) analyzed by the monitoring data analyzer 136, on a screen.

Also, the monitoring data visualizer 137 functions to visualize an urgent MT transferred from the monitoring data collector 134 on a screen.

Hereinafter, referring to FIGS, a DDS monitoring method of the DDS monitoring apparatus (130 of FIG. 1) according to an embodiment of the present invention will be described.

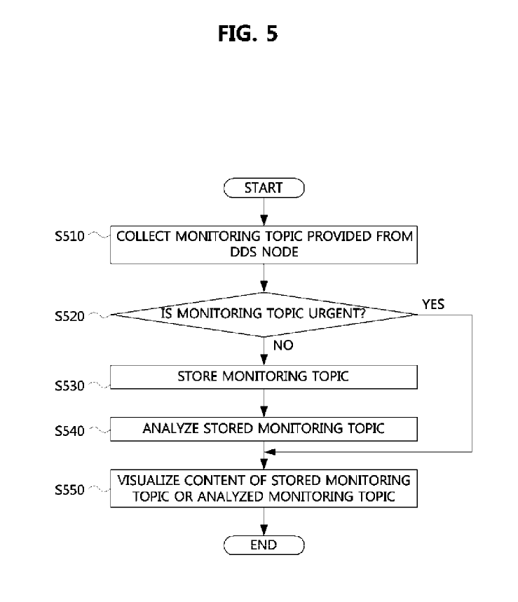

FIG. 5 is a flowchart illustrating a method in which the DDS monitoring apparatus 130 monitors a DDS, according to an embodiment of the present invention.

As illustrated in FIG. 5, at S510, an MT is provided from a DDS node and collected and the MT includes information regarding the operational record of history of the DDS node, etc.

At S520, it is determined whether the MT includes urgent content.

If the MT includes urgent content, at S550, the content of the MT is visualized on a screen.

On the other hand, if the MT includes no urgent content, at 530, the MT is stored, and at S540 the MT is analyzed based on the stored MT and a DDS status is recognized. Successively, at S550, the content of the analyzed MT is visualized on the screen.

The DDS monitoring apparatus according to the current embodiment can quickly process an error and defect generated in a DDS node by allowing a manager to recognize the error and defect in real time.

Also, the DDS monitoring apparatus according to the current embodiment can recognize the data flow between DDS nodes and a network status so that a DDS network can be stably managed.

Also, the DDS monitoring apparatus according to the current embodiment in order to implement a DDS monitoring function uses the data distribution function of DDS communication middleware, instead of using a separate protocol for data exchange for monitoring, thereby making it possible to minimize a cost for adding a monitoring function.

In the embodiments described above, individual components are shown to be included in different blocks, however, they may be configured to be included in a single block. For example, the components may be configured to be included in a controller, a processor, etc. to perform a series of operations.

While the example embodiments of the present invention and their advantages have been described in detail, it should be understood that various changes, substitutions and alterations may be made herein without departing from the scope of the invention.

What is claimed is:

1. A data distribution service (DDS) monitoring apparatus comprising:
a monitoring participant configured to receive a monitoring topic from a DDS node, wherein the monitoring topic is status information of the DDS node;
a monitoring data collector configured to collect the monitoring topic, and to determine whether or not the monitoring topic is urgent; and
a monitoring data analyzer configured to analyze the monitoring topic according to whether or not the monitoring topic is urgent to determine whether to create DDS status information corresponding to the status of the DDS nodes.

2. The DDS monitoring apparatus of claim 1, further comprising a monitoring data visualizer configured to visualize at least one of the DDS status information and the monitoring topic on a screen.

3. The DDS monitoring apparatus of claim 2, further comprising a monitoring data storage configured to store the monitoring topic.

4. The DDS monitoring apparatus of claim 3, wherein the monitoring data collector provides the monitoring topic to the monitoring data visualizer if the monitoring topic is urgent, and if the monitoring topic is not urgent, the monitoring data collector stores the monitoring topic in the monitoring data storage so that the stored monitoring topic is analyzed.

5. The DDS monitoring apparatus of claim 1, wherein the monitoring participant includes a monitoring subscriber configured with a monitoring reader for receiving the monitoring topic from the DDS node.

6. The DDS monitoring apparatus of claim 1, wherein the monitoring topic is defined according to a method of defining a predetermined data topic, and stored in DDS communication middleware.

7. A data distribution service (DDS) node interworking with a DDS monitoring apparatus, comprising:
an application configured to execute an installed application program to perform a allocated task;
a data participant configured to transmit/receive data using a topic; and
a monitoring participant configured to collect a monitoring topic which is information generated when the task is performed and when the data is transmitted/received, and to provide the monitoring topic to the DDS monitoring apparatus.

8. The DDS node of claim 7, providing the monitoring topic to the DDS monitoring apparatus through DDS communication middleware.

9. The DDS node of claim 7, wherein the data participant includes a data publisher for transmitting the data, and a data subscriber for receiving the data.

10. A data distribution service (DDS) monitoring method of a DDS monitoring apparatus, comprising:
receiving a monitoring topic from a DDS node, wherein the monitoring topic is status information of the DDS node;
collecting the monitoring topic, and determining whether or not the monitoring topic is urgent; and
determining whether to create DDS status information corresponding to the status of the DDS node by analyzing the monitoring topic according to whether or not the monitoring topic is urgent.

11. The DDS monitoring method of claim 10, further comprising visualizing at least one of the DDS status information and the monitoring topic on a screen.

12. The DDS monitoring method of claim 11, further comprising storing the monitoring topic if the monitoring topic is not urgent.

13. The DDS monitoring method of claim 12, wherein the collecting of the monitoring topic comprises:
visualizing the monitoring topic on the screen if the monitoring topic is urgent; and
storing the monitoring topic if the monitoring topic is not urgent so that the stored monitoring topic is used in analyzing the monitoring topic.

14. The DDS monitoring method of claim 10, wherein the monitoring topic is defined according to a method of defining a predetermined data topic, and stored in DDS communication middleware.
